(19) United States
(12) Patent Application Publication
(10) Pub. No.: US 2009/0233494 A1
(43) Pub. Date: Sep. 17, 2009

(54) USB-B Connector With eSATA Interface

(76) Inventor: Chun-Chi Wang, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 12/110,289

(22) Filed: Apr. 26, 2008

(30) Foreign Application Priority Data
Mar. 17, 2008 (TW) 097204583

(51) Int. Cl. H01R 13/40

(52) U.S. Cl. 439/752.5

(57) ABSTRACT

A USB-B connector with an eSATA interface is provided. The connector includes a socket with a tongue plate placed inside the socket. The socket conforms to the USB-B specification. The socket further includes a plurality of pins, which are located on the upper and lower surfaces of the tongue plate, or the inner wall of the socket. The pins form a strand USB-B pin-set and an eSATA in-set. The eSATA pin-set shares some pins with the USB-B pin-set. When using the connector of the present invention, an external storage device can use either USB or eSATA interface for transmission.

### FIELD OF THE INVENTION

The present invention generally relates to a connector, and more specifically to a connector conforming to USB-B specification and able to receive transmissions from both USB and eSATA interface.

### BACKGROUND OF THE INVENTION

Universal Serial Bus (USB) is an interface widely used in computer peripherals. The main reason behind popularity of USB is the support of hot plug and plug-and-play. The early USB 1.1 has the maximum bandwidth 12 Mbps, while the current USB 2.0 supports 480 Mbps. As different electronic devices are developed and marketed, the related storage devices for these electronic devices also gains attention. Many users experience various inconvenience in using storage devices. For example, when trying to use an external storage device, such as hardisk or DVD player, for data exchange between two hosts, the data processing time is usually very long. With the current HDTV files commonly of the size of multiple giga-bytes, the data exchange usually takes a long time for the current USB 2.0 bandwidth.

On the other hand, an external serial ATA (eSATA) interface is developed to alleviate the above problem. eSATA is an extension of the industrial standard interface SATA, with more durable cable and connector. eSATA supports both hot plug and plug-and-play, with the maximum transmission speed of 3 Gb/sec. Hence, eSATA interface greatly reduces the backup time in comparison with the USB external harddisk. In addition to data backup and protection, eSATA also boasts of better performance, especially for external DV audiovisual applications that require high bandwidth and low storage cost. eSATA extends the built-in SATA standard to the external device to realize the cost-effective external storage devices. This not only improves the storage capacity, but also enhances data protection, so as to provide better performance than the USB interface.

However, USB is still the most popular transmission interface for an external storage device. For an external storage device, if only an eSATA interface is included, the disadvantage is the possible incompatibility with most other hardware devices although the eSATA transmission interface allows higher speed transmission. Furthermore, the external storage device with eSATA interface usually requires an external power supply. Therefore, the solution may be for an external storage device to include a USB-B connector as well as an eSATA connector so that both transmission speed and compatibility can be both maximized. However, the inclusion of two connectors has the following disadvantages:
1. higher cost with two connectors;
2. requiring an external power supply to provide power to eSATA interface; and
3. maybe unsuitable for external storage device with size limitation of design consideration due to more connectors and possible complicated structure.

### SUMMARY OF THE INVENTION

The primary object of the present invention is to provide a USB-B connector with eSATA interface, including a connector of USB-B specification, and modified to accommodate eSATA pins so that a single connector containing a USB-B interface and an eSATA interface.

Another object of the present invention is to provide an external storage device with eSATA interface that does not require an external power supply. The storage device using the connector of the present invention can obtain power from the Vbus pin of USB so that no extra power supply is required.

Yet another object of the present invention is to provide a small-size connector applicable to external storage devices having size limitation of design consideration, including having both USB interface and eSATA interface to reduce the manufacturing cost as well as maximizing the compatibility and high transmission speed.

To achieve the above objects, the present invention provides a connector, having the shape of a fixed base. The connector includes a socket with a tongue plate placed inside the socket. The socket conforms to the USB-B specification. The socket further includes a plurality of pins, which are located on the upper and lower surfaces of the tongue plate, or the inner wall of the socket. The pins form a strand USB-B pin-set and an eSATA in-set. The eSATA pin-set shares the middle pins of the USB-B pin-set.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a connector according to the present invention;

FIG. 2 shows a schematic view of the connector of FIG. 1 from a different angle;

FIG. 3 shows a schematic view of a USB-B plug with eSATA interface according to the present invention; and

FIG. 4 shows schematic view of a USB-B plug with eSATA interface of FIG. 3 from a different angle.

### DETAILED DESCRIPTION OF THE PREFERRED EMBODIMENTS

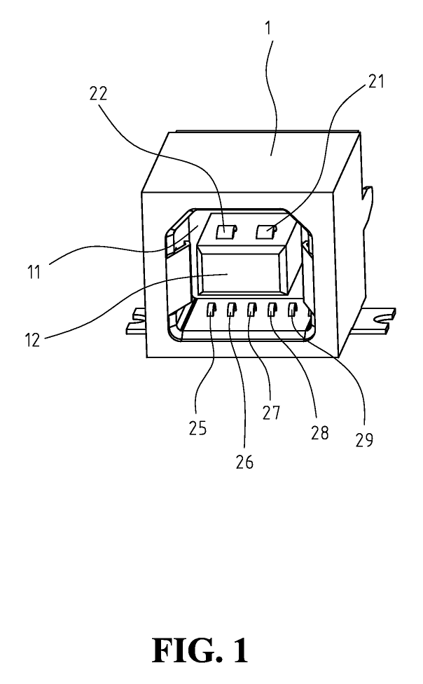

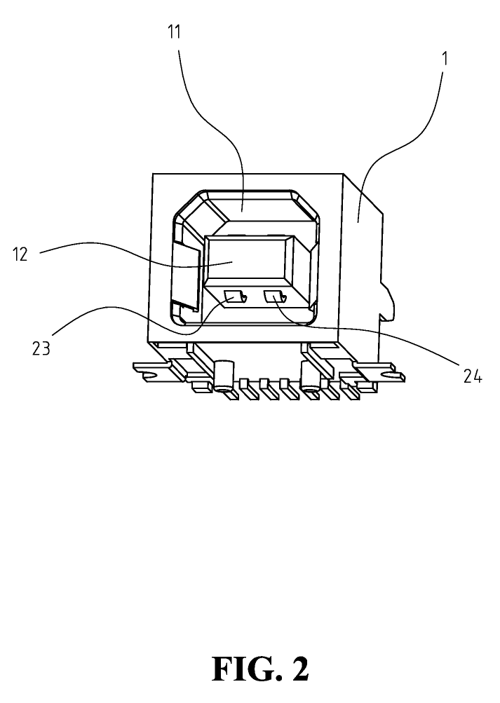

FIG. 1 and FIG. 2 show schematic views of the USB-B connector with eSATA interface from different angles. A connector 1 is shaped as a rectangular fixed base. Connector 1 includes a socket 11. Socket 11 conforms to the USB-B specification. Inside of socket 11 are a tongue plate 12 and a plurality of pins 21-29. Pins 21-24 are located on the upper surface and the lower surface of tongue plate 12 to form a standard USB pin-set. In other words, USB-B pin-set is an interface for receiving a USB-B plug to plug in. On the other hand, pins 21, 24 and pins 25-29 form an eSATA pin-set to receive a USB-B plug with eSATA interface to plug in. The USB-B plug with eSATA interface can be plugged into the standard USB-B connector and connector 1 of the present invention, but not into the standard eSATA connector. In other words, the eSATA pin-set of the present invention is not compatible to the standard eSATA plug. The eSATA signal pins of the eSATA pin-set of the present invention are pins 25-29. Pins 25-29 are located on the bottom inner wall of socket 11. The shared pins are pins 21, 24. The tips of pins 21-29 will extend beyond to the outside of connector 1 for connecting to the circuit on the circuit board.

In the present invention, USB pin-set includes pins 21-24. Pin 21 is Vbus, pin 22 is D−, pin 23 is D+, and pin 24 is GND. eSATA signal pins are pins 25-29. Pins 25, 26 are TX+, TX−, respectively. Pin 27 is GND. Pins 28, 29 are RX+, RX−, respectively. When connector 1 of the present invention is applied to an external storage device, Vbus (pin 21) of the USB pin-set can supply the power; hence, no external power supply is necessary for the external storage device.

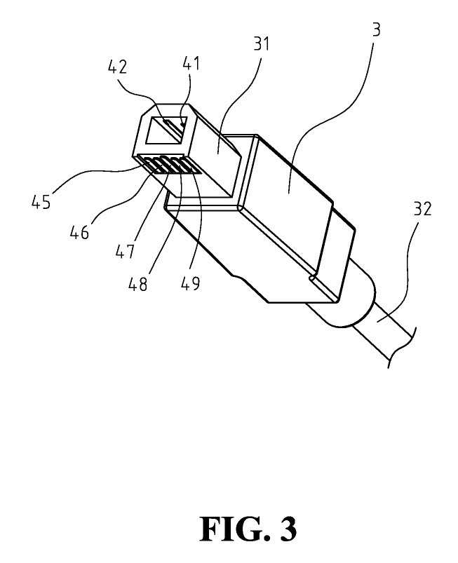

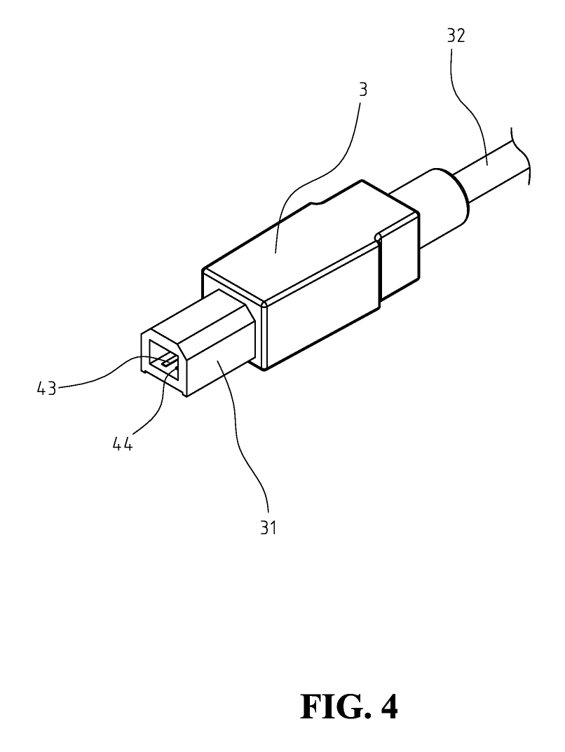

FIG. 3 and FIG. 4 show different schematic views of the USB-B plug with eSATA interface used in the present invention, respectively. A USB-B plug 3 with eSATA interface is designed to match connector 1. USB-B plug 3 with eSATA interface can be plugged to connector 1 for either USB interface transmission or eSATA interface transmission. In addition, USB-B plug 3 with eSATA interface can also be plugged into a standard USB-B connector for USB interface transmission. The front part of USB-B plug 3 with eSATA interface includes a connector 31, and the rear part includes a cable 32. The shape of connector 31 is a pentagon-like frame to match the shape of socket 11 of connector 1. Connector 31 includes a plurality of contact ends 41-49. Contact ends 41-44 are located inside the upper wall and lower wall of the frame to form the USB signal ends. Contact 45-49 are located on the outer surface of the bottom wall of the frame of connector 31 to form eSATA signal ends. Contact ends 41-49 are electrically connected to the signal lines of cable 32, respectively.

The following describes the use of the connector of the present invention applied to an external storage device, such as external harddisk or external DVD player.
Scenario 1: The user plugs a cable with USB plug into the connector. The external storage device uses the Vbus of the USB pin-set of the connector directly as the power supply of DC 5V; therefore, no external power supply is necessary.
Scenario 2: The user plugs a USB-B plug with eSATA interface into the connector. There are three possible cases:
1. One of the devices connected to the cable with the USB-B plug with eSATA interface can only execute USB interface transmission. In this case, the transmission is executed through the USB interface.
2. if the external storage device can only use eSATA interface transmission, the Vbus of the USB pin-set of the connector will supply the power of DC 5V for eSATA transmission; therefore, no external power supply is necessary.
3. Both devices connected to the cable with the USB-B plug with eSATA interface can use both USB interface transmission and eSATA interface transmission. A pre-defined priority can be used to determine whether the transmission will be executed using USB interface or eSATA interface. In general, eSATA is set to have a higher priority.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A USB-B connector with an eSATA interface, comprising:
a socket, having a tongue plate located inside said socket, said socket having the shape conforming to USB-B specification, said socket further comprising a plurality of pins inside said socket, said plurality of pins forming a standard USB-B pin-set and an eSATA pin-set, and said eSATA pin-set sharing some said pins with said USB-B pin-set.

2. The connector as claimed in claim 1, wherein said connector can receive a standard USB-B plug.

3. The connector as claimed in claim 1, wherein said connector can receive a USB-B plug with an eSATA interface.

4. The connector as claimed in claim 1, wherein said eSATA pin-set shares Vbus pin with said USB-B pin-set.

5. The connector as claimed in claim 3, wherein said USB-B plug with an eSATA interface comprises a connector having the shape of a pentagon-like frame matching the shape of said socket, and said connector having a plurality of contact ends on the inner and outer surface of said frame.

6. The connector as claimed in claim 3, wherein said USB-B plug with an eSATA interface can be plugged into a standard USB-B connector.
